(19) United States
(12) Patent Application Publication
(10) Pub. No.: US 2004/0268321 A1
(43) Pub. Date: Dec. 30, 2004

(54) System and method for cross-platform computer access

(76) Inventors: Barrett M. Kreiner, Norcross, GA (US); Andre D. Jarboe, Stone Mountain, GA (US)

Correspondence Address: WOODCOCK WASHBURN LLP, ONE LIBERTY PLACE - 46TH FLOOR, PHILADELPHIA, PA, 19103, US

(21) Appl. No.: 10/607,895

(22) Filed: Jun. 27, 2003

(51) Int. Cl. G06F 9/45

(52) U.S. Cl. 717/136; 717/114; 717/137

(57) ABSTRACT

A system for remote computer access comprises a first computer upon which an application runs, and a second computer upon which outputs from the application are implemented and from which inputs to control the application are received. A network communicatively couples the first and second computing systems. As an application executes on the first computing system, output-related instructions such as those related to displaying data are translated into a non-proprietary data format such as, for example, an extensible markup language (XML) data item. The XML data item is transmitted over the network using non-proprietary protocols such as, for example, HTTP to the second computing system. At the second computing system, the output-related instruction is translated into a corresponding instruction native to the second computing system and thereafter executed on the second computing system. Inputs such as those from a mouse or keyboard that are received at the second computing system are translated into a non-proprietary, open data item such as, for example, an XML data item. The translated input instruction is transmitted from the second computing system to the first computing system over the communicative network using non-proprietary protocols such as HTTP. Upon receipt at the first computing system, the input instruction is translated into a format native to the first computing system and implemented.

### FIELD OF THE INVENTION

The disclosed systems and methods relate generally to computing, and more particularly, to remote computer access.

### BACKGROUND

It frequently happens that persons need to access computing systems from remote locations. For example, a system administrator may need to access a server computer after business hours, possibly from a home computer. Similarly, a business traveler may need to access his or her office computer while they are on the road. Indeed, there are innumerable examples of situations where persons need to remotely access a computing system.

Several existing software products allow for remote computer access. These include, for example, pcAnywhere from Symantec Inc., Sun Ray from Sun Microsystems, Virtual Network Computer (VNC) by AT&T Labs Cambridge, and the X-Windows system. Generally, existing remote access software systems comprise a software server located on the machine that is being accessed, and a software client located on a remote computer from which access is obtained. While a software program executes on the computing system with the software server located thereon, the output is displayed on, and the inputs are received at the remote computing system with the software client thereon. For example, a system administrator may use his or her home computer and remote access software to take control of and execute software on a computing system located at the work location. The inputs are taken from, and the outputs are directed to the administrator's home computer even though the software is actually running on the computer located at work.

Applicants have noted that in existing remote access software systems, proprietary data formats and communication protocols are frequently employed. Proprietary data formats and communications protocols are often less than efficient and fail to leverage the open and non-proprietary technologies that are widely available and employed in modern computing systems such as the Internet and World Wide Web (the Web). Furthermore, the proprietary data formats and communication protocols often do not function properly across firewalls and other protective measures that frequently exist in public networks such as the Internet.

Applicants have also noted that existing remote access systems do not allow for remote cross-platform access. For example, computing system users may wish to remotely access a software application using an interface that is not typically used to access the particular application. For example, a user may wish to use a telephone to access a software application that is typically accessed using a standard keyboard and monitor interface. The telephone through which the user may need to access the application may have a telephone keypad and audio interface. In some instances, the telephone may have a very limited graphical interface. In any event, accessing the application using an entirely different interface from that normally used to access a software application is not provided for in existing remote access systems.

### SUMMARY

Applicants disclose herein illustrative systems and methods for providing remote computer access. The disclosed systems and methods leverage non-proprietary and open technologies and are operable over public networks such as the Internet that employ security protections such as firewalls. Furthermore, the disclosed systems and methods allow for remote cross-platform access to software applications.

In an illustrative embodiment, a system for remote computer access comprises a first computing system upon which an application executes, and a second device, which may be, for example, another computer, a PDA, a telephone, or other device upon which outputs from the application are implemented and from which inputs to control the application are received. A network, which may be, for example, the Internet communicatively couples the first and second computing devices.

According to a disclosed embodiment, as an application executes on the first computing system, output-related instructions such as those related to displaying data or creating sounds are translated into a non-proprietary data format such as, for example, an extensible markup language (XML) data item. In an alternative disclosed embodiment, the application executing on the first computing system may generate instructions directly in XML format and, therefore, may not require translation. The XML data items, which may be any XML formatted data such as, for example, XML data elements with attributes, a hierarchy of XML elements, or even simply an XML attribute, are transmitted over a network using non-proprietary protocols such as, for example, TCP/IP and HTTP to the second device.

According to a disclosed embodiment, at the second device, the output-related instructions formatted as XML data items are translated into corresponding instructions native to the second computing system and thereafter executed on the second device. In an alternative embodiment, the second device is operable to read XML directly and, therefore, accepts and operates on the XML data items without translation.

According to an aspect of the disclosed systems and methods, the second device may have pre-defined user preferences stored thereon that dictate characteristics of the user interface. For example, the pre-defined user preferences may be expressed in Extensible Stylesheet Language (XSL) and dictate the color of the background, the size and color of the text, the arrangement of the text on the display, or any other interface characteristic. Thus, when the XML data items are received at the second device, the second device may invoke pre-defined user preferences stored in XSL to determine how to present the user interface.

According to a disclosed embodiment, inputs such as those from a mouse, keyboard, or telephone keypad that are received at the second computing system are translated into non-proprietary, open data items such as, for example, XML data items. According to an alternative embodiment, inputs entered at the second computing system are directly generated in a non-proprietary format such as, for example, XML and therefore do not require translation. The XML data items are transmitted from the second computing system to the first computing system over the communicative network using non-proprietary protocols such as HTTP and TCP/IP.

Upon receipt at the first computing system, according to a disclosed embodiment, the input instructions are translated from XML into a format native to the first computing system and implemented. In an alternative embodiment wherein the first computing system is operable to directly read XML, the XML data items are read and operated upon without translation.

### BRIEF DESCRIPTION OF THE DRAWINGS

Other features of the illustrative system and method will be further apparent from the following detailed description taken in conjunction with the accompanying drawings, of which:

FIG. 1 is a diagram of illustrative computing systems communicatively coupled via a network;

FIG. 2 is a diagram of illustrative computing systems, depicted in block diagram, communicatively coupled via a network;

FIG. 3 is a flow chart of an illustrative method for remote computer access; and

FIG. 4 is a diagram of a generic computing system that may be suitable for implementing the disclosed methods.

### DETAILED DESCRIPTION

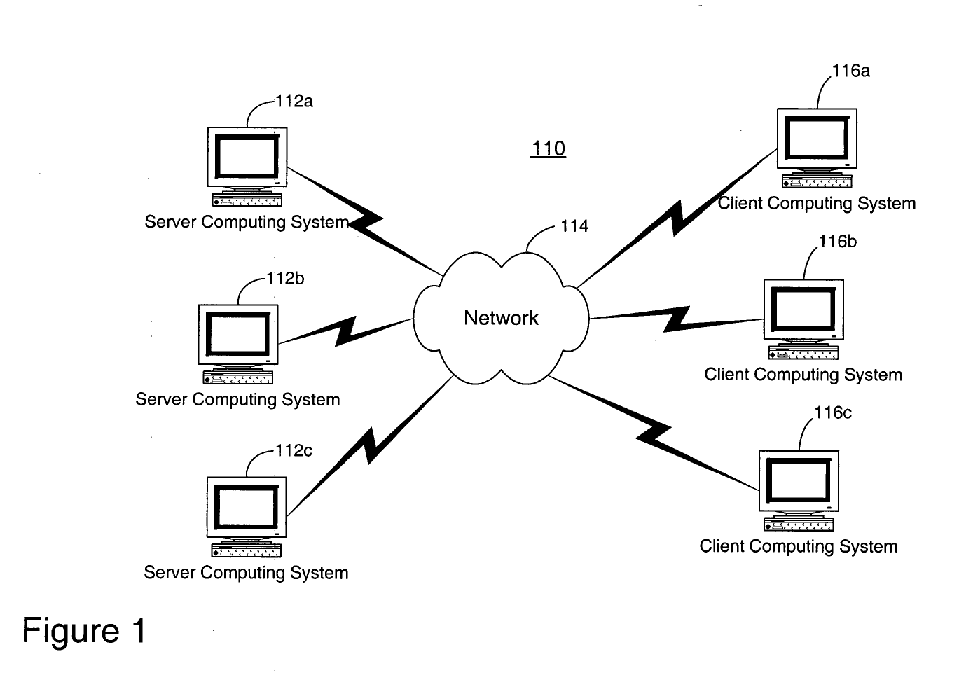

FIG. 1 is a diagram of illustrative computing network 110 for providing remote cross-platform computer access. As shown, illustrative computing network 110 comprises a plurality of first computing systems 112a-c, referred to herein as server computing systems, which may be, for example, server computers or any other computing system having software thereon that a person might wish to remotely access. Server computing systems 112a-c are communicatively coupled to communications network 114, which may comprise numerous communication mediums such as, for example, serial line communications, wireless networks (including for example, WiFi, Ultrawideband, Bluetooth, and satellite networks), shared memory, and TCP/IP-based networks such as, for example, the Internet. A plurality of second computing systems 116a-c, which may be referred to as client computing systems, are also communicatively coupled to communications network 114. Server computing systems 112a-c and client computing systems 116a-c may be numerous different computing devices such as, for example, a standard computing system comprising a keyboard, monitor, and mouse, a telephone with a keypad and optional graphical display, or a personal digital assistant (PDA). Computing systems 112a-c and 116a-c are operable to communicate with each other over network 114 using open non-proprietary protocols such as, for example, TCP/IP and HTTP. HTTP is not the only mechanism of transport that may be used, but it facilitates remote access as it can easily pass through Internet firewalls.

It is often desirable to access a server computing system such as server computer system 112a via a client computing system such as, for example, client computing system 116a. For example, a system administrator may desire to perform administrative tasks such as, for example, running system backups on server computing system 112a from client computing system 116a. In other words, the administrator may wish to remotely control server computing system 112a from client computing system 116a. Thus, while a program may actually be running on server computing system 112a, the output is displayed on, and the administrator inputs are received at client computing system 116a.

During a remote control session, instructions comprising user inputs are routed from client computing system 116a to server computing system 112a, and instructions comprising system outputs are routed from server computing system 112a to client computing system 116a. In an illustrative embodiment, the instructions are formatted as XML items and are communicated using standard communication protocols such as, for example, HTTP. Those skilled in the art will recognize that XML formatted data can be compressed as it moves through network 114.

In an embodiment of the disclosed systems and methods, client computing system 116a and server computing system 112a may be different types of computing devices with different user interfaces. For example, client computing system 116a may be a PDA with a touch screen interface while server computing system 112a may be a general purpose computer with a keyboard, monitor, and mouse interface. Client computing system 116a and sever computing system 112a communicate instructions between each other as XML items and each system is operable to read the XML items and implement the relevant instructions using its own particular interface. Thus, even though server computing system 112a may have a user interface that employs a keyboard, monitor, and mouse, the applications thereon can be controlled by a device 116a that has a different computing interface. Indeed, a non-display system such as one that employs a script or voice interface only can interact with a device that is designed to interact with a graphical interface. Each device is operable to send and receive instructions as XML data items and to implement such instructions on its own particular hardware and interface. Furthermore, devices 112a and 116a may employ Extensible Stylesheet Language (XSL) and XSL Transformations (XSLT) to obtain customized interfaces. Use of XML, XSL, and XSLT allows for local control of the look and feel and presentation of a remote application.

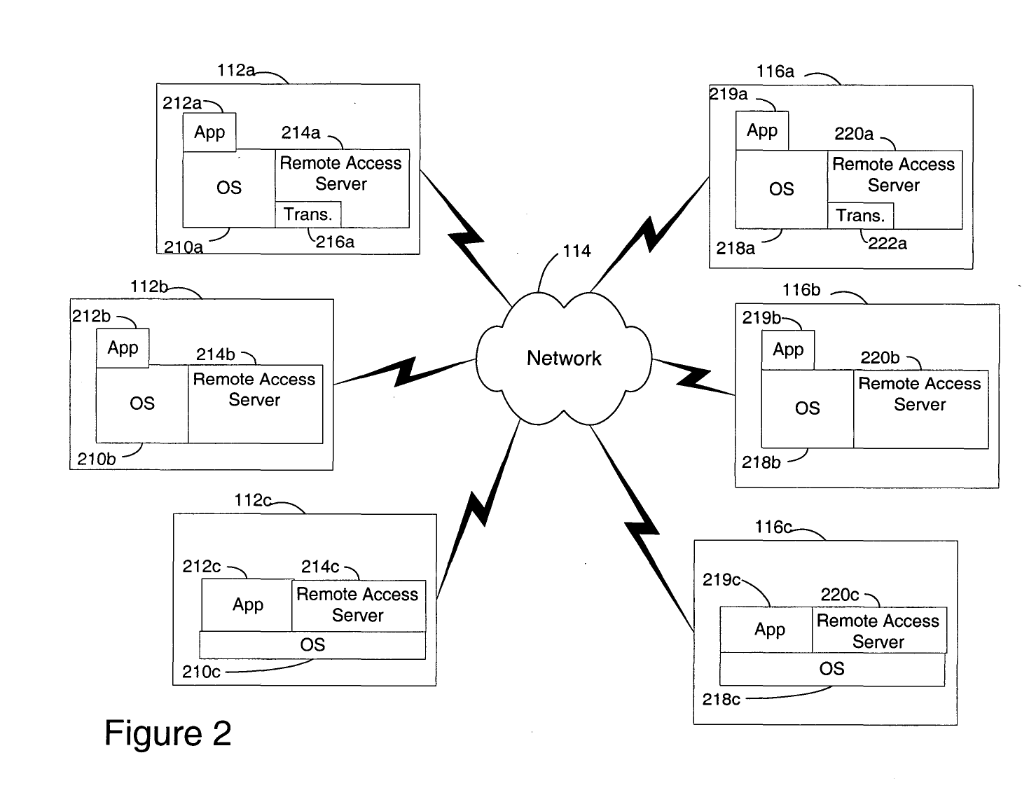

FIG. 2 is a diagram of illustrative server computing system 110 with server systems 112a-c and client systems 116a-c shown in block diagram format.

Server computing system 112a may comprise, for example, an operating system (OS) 210a and application software 212a. OS 210a may be any of numerous different operating systems such as, for example, Microsoft Windows, Linux, and PalmOS. Generally, application software 212a runs on OS 210a and provides user-desired functionality. For example, application software 212a may be general office automation software such as word processing, spreadsheet, or drawing software. Likewise, application software 212a may be directed to performing system administrative tasks such as, for example, performing system backups or monitoring system usage.

Generally, applications software 212a executes on top of OS 210a. Thus, commands from application software 212a are implemented through OS 210a. For example, input-related commands such as those for receiving inputs from a mouse or keyboard and output-related commands such as those for outputting data to a monitor or speaker are routed through and implemented by OS 210a. Those skilled in the art will recognize in some embodiments of the disclosed systems, application software 212a may comprise or be comprised in OS 210a.

Server computing system 112a further comprises remote access server software 214a. Generally, remote access server software 214a handles connections from remote computing systems such as, for example, client computing systems 116a. Servicing remote connections may comprise, for example, receiving input data from client computing systems 116a-c via network 114, and forwarding output data from server computing system 112a to client computing systems 116a-c. Thus, the inputs are received from, and the outputs are routed to client computing systems 116a-c, even though the actual processing occurs on server computing systems 112a. Remote access server 214a-c may be implemented in software using numerous different techniques including, for example, as an embedded service or as a dynamic linking library.

As shown in FIG. 2, remote access server 214a comprises translator 216a. Generally, translator 216a operates in server systems 112a to translate input and output related instructions between a native format of the OS 210a and an open non-proprietary format such as, for example, XML. Thus, when an output-related instruction such as, for example, an instruction for displaying a file or generating a sound is processed by OS 210a on server computing systems, remote access server 214a recognizes the instruction as one that needs to be forwarded to one of client computing system 116a-c, and before forwarding the instruction, translates the instruction in translator 216a from its native format into an XML formatted data item. Thereafter, the XML data item is communicated over network 114 to one of client computing system 116a-c where the XML is processed to render an instruction that is understandable by one of client computing systems 116a-c. Similarly, input-related instructions such as mouse and keyboard inputs that are received at server computing system 112a from client computing systems 116a-c via network 114 arrive as an XML format data item and are translated by translator 216a into a corresponding native instruction format of server computing system 112a.

In an illustrative server system 112a, remote access server 214a and translator 216a are integrated with OS 210a. In one embodiment, translator 216a may be incorporated into the physical device drivers that are part of OS 210a. Thus, in addition to driving a physical device such as a display or sound card, the device drivers may translate the native instructions into a non-proprietary data format such as XML for transmission to client computing system 116a-c.

Server computing system 112b comprises OS 210b and application 212b, which operate generally as described above in connection with system 112a. As shown, OS 210b further comprises remote access server 214b, which also operates generally as described above in connection with system 112b. Notably, server computing system 112b does not comprise a translator. Rather, OS 210b is operable to create and receive commands directly in an open format such as, for example, XML. Therefore, there is no need to translate commands to and from OS 210b's native format prior to and after transmission across network 114.

Server computing system 112c comprises OS 210c and application 212c, both of which operate generally as described above in connection with system 112a. In server computing system 112c, remote access server 214c is integrated with application 212c, rather than with OS 210c. Thus, application 212c in combination with remote access server 214c is operable to communicate over network 114 without interfacing with OS 210c. Server computing system 112c does not comprise a translator. Rather, application 212c is operable to create commands directly in an open format such as, for example, XML. Therefore, there is no need to translate commands to and from application 212c's native format prior to and after transmission across network 114.

Client computing systems 116a-c are operable to remotely access applications executing on sever computing systems 112a-c.

As shown in FIG. 2, client computing system 116a comprises OS 218a and application software 219a. Client computing system 116a further comprises client access software 220a. Generally, client access software 220a identifies input-related instructions such as mouse and keyboard inputs and processes the instructions in translator 222a. Translator 222a converts the native instruction format of OS 218a into an open standard format instruction represented by an XML element. The XML element is forwarded over network 114 to the one of server computing systems 112a-c with which system 116a is remotely controlling. Client access software 220a also operates to receive XML elements representing output-related instructions from server computing system 112 via network 114. The XML formatted output instructions are processed by translator 222a to arrive at instructions in a native format that can be processed by OS 210.

In client computing system 116a, client access software 220a and translator 222a are integrated with OS 218a. Furthermore, translator 222a may be incorporated into the physical device drivers that are part of OS 218a. Thus, in addition to driving a physical device such as a keyboard or mouse, the device drivers may translate the native instructions to a non-proprietary data format such as an XML element prior to transmission to server computing system 112. Furthermore, in an alternative embodiment, translator 222a may be incorporated into specialized hardware such as a graphical processing unit (GPU).

Client computing system 116b comprises OS 218b and application 219b, which operate generally as described above in connection with system 116a. OS 218b further comprises remote access server 220b, which also operates generally as described above in connection with system 116b. Notably, server computing system 116b does not comprise a translator. Rather, OS 218b is operable to create and receive commands directly in an open format such as, for example, XML data format. Therefore, there is no need to translate commands to and from OS 218b's native format prior to and after transmission across network 114.

Client computing system 116c comprises OS 218c and application 219c, both of which operate generally as described above in connection with system 116a. In server computing system 116c, remote access server 220c is integrated with application 219c, rather than with OS 218c. Thus, application 219c in combination with remote access server 220c is operable to communicate over network 114 without interfacing with OS 218c. Client computing system 116c does not comprise a translator. Rather, application 219c is operable to create commands directly in an open format such as, for example, XML data format. Therefore, there is no need to translate commands to and from application 219c's native format prior to and after transmission across network 114.

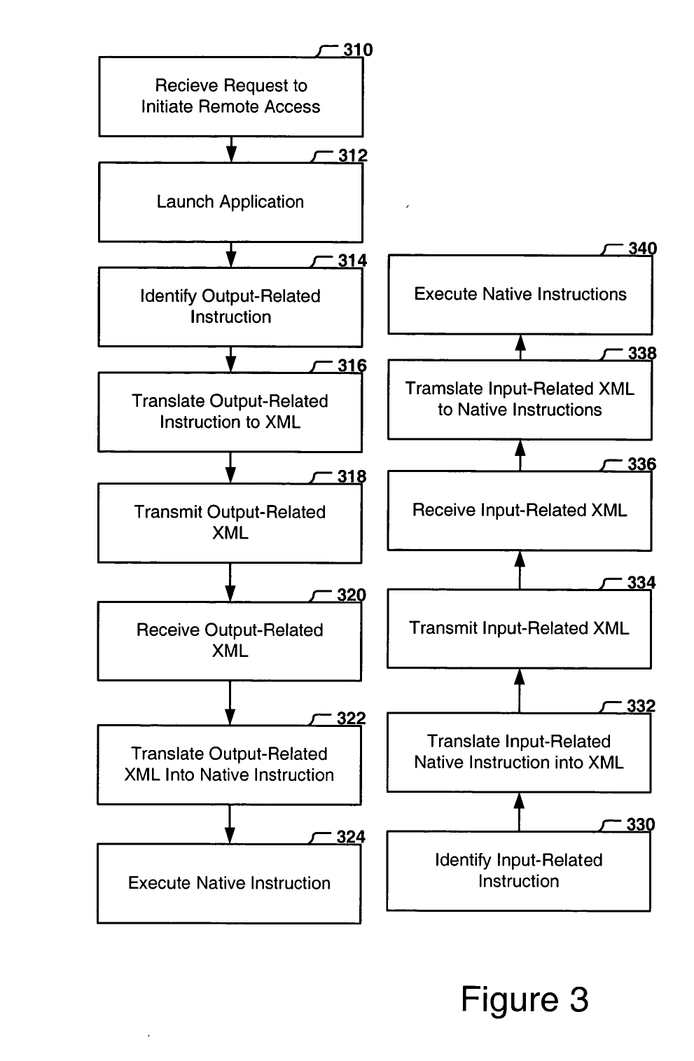

FIG. 3 is a flow chart of an illustrative process for providing remote computer access. As shown, at step 310, a request to initiate a remote access session is received at one of server computing systems 112, for example system 112a, from one of client computing systems 116, for example system 116a, via network 114. In an illustrative embodiment, the request is received and handled by remote access server 214a. At step 312, remote access server 214a causes the desired application, which may be application 212a of FIG. 2, to be launched on system 112a. During execution of application 212a on OS 210, remote access server 214a recognizes, at step 314, an output-related instruction such as, for example, an instruction related to displaying data or generating a sound. At step 316, translator 216a translates the instruction from a native format for execution by OS 210 into an open system data item such as, for example, an XML element. XML is a markup language that is used to describe data and is known by those skilled in the art. While those skilled in the computing arts are knowledgeable regarding XML and can implement an XML system, background regarding implementing XML systems is disclosed at www.w3c.org, the contents of which are hereby incorporated by reference in their entirety. Generally, an XML element is defined by at least a beginning tag, a data item corresponding to the element content, and a closing tag. For example, a native OS 210 instruction for displaying a file (referred to as filename) may be translated into an XML element such as the following: <display>filename</display>. The tag “<display>” represents the beginning of the XML element, the tag “</display>” represents the end of the XML element, andfilename corresponds to the data to be displayed. Similarly, a native OS 210 instruction for playing an audio file may be translated by translator 216 into an XML formatted data item, for example, such as the following: <play>filename</play>. Indeed, an XML equivalent may be developed for all native instructions. Translator 216 may maintain a database matching native instructions to corresponding XML elements. For example, an instruction to display a file may be matched to XML tags “<display>” and “</display>”. Upon receiving an output native instruction, translator 216 may access the database to identify the corresponding XML element(s). At step 316, OS 210 may also execute the instruction that is being translated so that the output is generated at server computing system 112 as well as at client computing system 116.

It should be noted that while exemplary server computing system 112a employs translator 216a, computing systems 112b and 112c do not employ translators, but rather both systems generate and process XML directly. Therefore, when server computing systems 112b and 112c are remotely accessed, step 316 relating to translating instructions is not necessary, and processing proceeds directly from step 314 to step 318.

At step 318, the output instruction is transmitted via network 114 to client computing system 116a. At step 320, the output instruction is received by client access software 220a. At step 322, the instruction is translated by translator 222a into a native format instruction for OS 218a. For example, an XML data item <display>filename</display> is translated into an instruction(s) which when executed by OS 218a cause the file to be displayed on system 116a. In a remote access session from client computing system 116b and 116c, translation is not necessary as the systems are operable to read XML items directly without translation. Therefore, in remote access sessions from client computing systems 116b and 116c, processing proceeds directly from step 320 to step 324.

At step 324, the output instructions are executed. In the exemplary scenario where the remote access session is established from client computing system 116a, the instructions are executed by OS 210a.

Inputs from client computing system 116a directed at controlling the execution of application 212a on server computing system 112a are forwarded to computing system 112a. Accordingly, at step 330, an input related instruction such as, for example, a mouse or keyboard input, are identified by client access software 220a. At step 332, translator 222a translates the instruction from the native format suitable for OS 218a to an open standard formatted data item such as, for example, an XML element. For example, a keyboard input comprising the depression of the “enter” key may be formatted as a combination of XML tags and data such as the following: <keyboard key=“Enter” keyboard action=“down”/>. Indeed, any native instruction corresponding to an input at client computing system 116a may be formatted into an open, non-proprietary format such as an XML formatted data element. Translator 222a may maintain a database of XML elements corresponding to each native input instruction. For example, translator 222a may maintain a database of XML relating the XML tags “<keyboard key>” and “<keyboard action>” with a native instruction indicating a keyboard key has been compressed. At step 332, translator 222 may access the database to identify the appropriate XML element.

In a remote access session from client computing system 116b and 116c, translation is not necessary as the systems are operable to create XML items directly without translation. Therefore, in remote access sessions from client computing systems 116b and 116c, processing proceeds directly from step 330 to step 334.

At step 334, the input instruction is communicated via network 114 to server computing system 112a. At step 336, remote access server 214a receives the input instruction. At step 338, the input instruction is translated by translator 216a into a format that can be executed by OS 210a. For example, at step 338, translator 216a may translate an XML data item such as <keyboard key=“Enter” action=“down”/> into the native instruction(s) for a “enter” key compression in OS 210a.

In a remote access session with server computing system 112b and 112c, translation is not necessary as the systems are operable to read XML items directly without translation. Therefore, in remote access sessions with server computing systems 112b and 112c, processing proceeds directly from step 336 to step 340.

At step 340, the translated instruction is executed by OS 210.

The method depicted in FIG. 3 allows for executing application 212a-c on server computing systems 112a-c, while directing outputs from application 212a-c to client computing systems 116a-c. Similarly, inputs received at client computing system 116a-c are routed to server computing systems 112a-c so as to control the operation of applications 212a-c. Thus, execution on server computing systems 112a-c is remotely controlled via client computing systems 116a-c. The illustrative method employs non-proprietary technologies such as XML and HTTP to implement the remote control. The use of standard open-system technologies allows for the disclosed method to operate over public networks such as the Internet that frequently employ security protections such as firewalls. Using XML as an intermediary transport data format allows for remote access between disparate computing environments. For example, even if computing systems 112a-c and 116a-c employ different operating systems, or are otherwise incompatible, the use of an intermediary data format, i.e. XML, allows for the remote control of server computing systems 112a-c by client computing systems 116a-c.

According to another aspect of the disclosed systems and methods, the XML items that are created and transmitted between server computing systems 112a-c and client computing systems 116a-c may be stored in a data file as they are created for later retrieval and playback. Thus, a remote session may be recorded as it is happening. Thereafter, the same session can be replayed, without a user physically directing the session. This feature is particularly useful for testing purposes as well as for quality assurance.

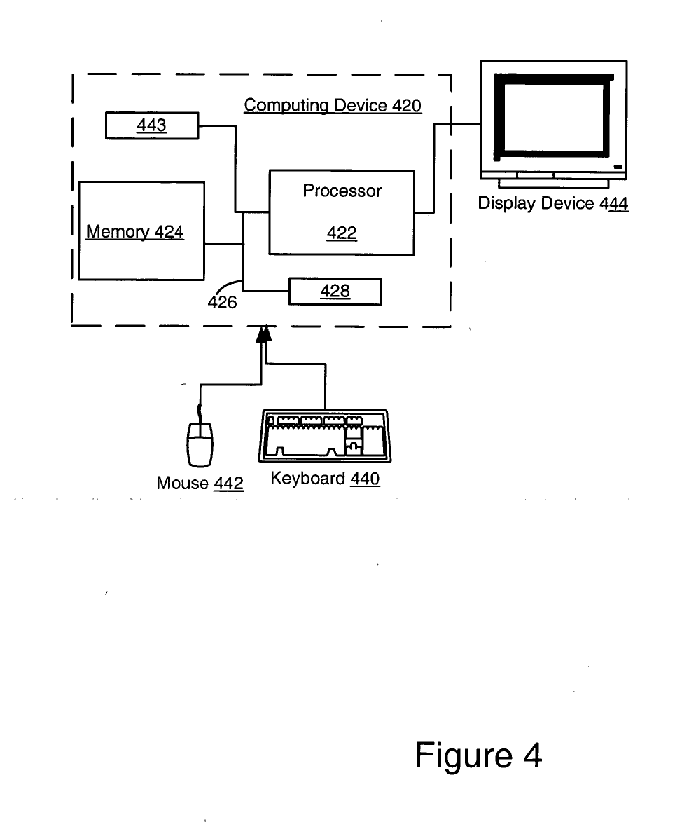

FIG. 4 is a diagram of a generic computing system that may be used to implement any of computing systems 112a-c or 116a-c. As shown in FIG. 4, computing device 420 includes processor 422, system memory 424, and system bus 426 that couples various system components including system memory 424 to processor 422. System memory 424 may include read-only memory (ROM) and/or random access memory (RAM). Computing device 420 may further include hard-drive 428, which provides storage for computer readable instructions, data structures, program modules, data, and the like. A user (not shown) may enter commands and information into computing device 420 through input devices such as keyboard 440 or mouse 442. Of course different input devices such as a telephone or PDA keypad or voice recognition input apparatus may also be used. A display device 444, such as a monitor, a flat panel display, or the like is also connected to the computing device 420 or output. Display device 444 may also include other devices such as a touch screen, a light pen, a grid of light beams, or the like for inputting information into processor 422. Communications device 443, which may be a modem, network interface card, or the like, provides for communications over network 114.

Processor 422 can be programmed with instructions to interact with other computing systems so as to perform the methods described above. The instructions may be received from network 114 or stored in memory 424 and/or hard drive 428. Processor 422 may be loaded with any one of several computer operating systems such as WINDOWS NT operating system, WINDOWS 2000 operating system, LINUX operating system, PalmOS, and the like.

Those skilled in the art understand that computer readable instructions for implementing the above-described processes, such as those described with reference to FIG. 3 can be generated and stored on one of a plurality of computer readable media such as a magnetic disk or CD-ROM. Further, a computing device such as that described with reference to FIG. 4 may be arranged with other similarly equipped computers in a network, and may be loaded with computer readable instructions for performing the above described processes. Specifically, referring to FIG. 4, microprocessor 422 may be programmed to operate in accordance with the above-described processes.

While the disclosed systems and methods have been described and illustrated with reference to specific embodiments, those skilled in the art will recognize that modification and variations may be made. For example, while the disclosed embodiments relate to remote control of a computing system over the Internet, remote control may be had using the above-disclosed methods over a private, non-public network as well. Likewise, while the disclosed illustrative embodiment employed HTTP and XML, other non-proprietary data formats and protocols may be employed as well. Furthermore, remote control sessions may be established between devices that are different and have different interfaces such as, for example, between a PDA and a Unix workstation. Accordingly, reference should be made to the appended claims as indicating the scope of the invention.

What is claimed is:

1. A method for providing remote computer access, comprising:
receiving a first instruction, said instruction for execution on a first computer;
translating the first instruction into data defining at least one XML item;
transmitting the data defining at least one XML item to a second computer;
translating the data defining at least one XML item into a second instruction, said second instruction for execution on the second computer; and
executing said second instruction on said second computer.

2. The method of claim 1, wherein receiving said first instruction comprises receiving an instruction for outputting data.

3. The method of claim 2, wherein receiving an instruction for outputting data comprises receiving an instruction for displaying data.

4. The method of claim 2, wherein receiving an instruction for outputting data comprises receiving an instruction for generating a sound.

5. The method of claim 1, wherein receiving said first instruction comprises receiving an instruction for inputting data.

6. The method of claim 5, wherein receiving an instruction for inputting data comprises receiving an instruction indicating a mouse input.

7. The method of claim 5, wherein receiving an instruction for inputting data comprises receiving an instruction indicating a keyboard input.

8. The method of claim 1, wherein translating the first instruction into data defining at least one XML item comprises generating a first XML tag defining the beginning of an XML item, generating a data item corresponding to the first instruction, generating a second XML tag defining the end of an XML item.

9. The method of claim 1, wherein transmitting the data to a second computer comprises transmitting the data using HTTP.

10. The method of claim 1, wherein translating the data into a second instruction comprises identifying a first XML tag defining the beginning of an XML item, identifying a data item corresponding to an instruction, identifying a second XML tag defining the end of an XML item.

11. The method of claim 10, wherein translating the data into a second instruction further comprises determining the second instruction corresponding to the data item.

12. Computer readable medium having computer-implementable instructions stored thereon for performing the method recited in claim 1.

13. A method for providing remote computer access, comprising:
receiving instructions relating to generating output;
translating the instructions relating to generating output into data defining at least one XML item;
transmitting the data defining at least one XML item;
receiving data defining an XML item relating to inputs;
translating the data defining an XML item relating to inputs into instructions relating to inputs; and
executing the instructions relating to inputs.

14. The method of claim 13, wherein receiving instructions relating to generating output comprises receiving instructions relating to generating visual or audio output.

15. The method of claim 13, wherein translating instructions relating to generating output into data defining at least one XML item comprises generating at least a first XML tag defining the beginning of the XML item, generating a data item corresponding to the instruction relating to generating output; and generating at least a second XML tag defining the ending of the XML item.

16. The method of claim 13, wherein transmitting the data defining at least one XML item comprises transmitting the data defining at least one XML item using HTTP protocol.

17. The method of claim 13, wherein translating the data defining an XML item relating to inputs comprises identifying a first XML tag identifying the beginning of the XML item, identifying a data item corresponding to an input, and identifying a second XML tag identifying the ending of the XML item.

18. A method for providing remote computer access, comprising:
receiving instructions relating to user inputs;
translating the instructions relating to user inputs into data defining at least one XML item;
transmitting the data defining at least one XML item;
receiving data defining an XML item relating to outputs;
translating the data defining an XML item relating to outputs into instructions relating to outputs; and
executing the instructions relating to outputs.

19. The method of claim 18, wherein transmitting the data defining at least one XML item comprises using the HTTP protocol to transmit the data defining at least one XML item.

20. A system for remote computer access, comprising:
a first computing system comprising software for identifying instructions relating to generating system outputs, transmitting data defining an XML item corresponding to the instructions relating to generating system outputs, and receiving XML items corresponding to user inputs;
a second computing system comprising software for identifying instructions relating to user inputs; transmitting data defining XML items corresponding to the instructions relating to user inputs, and receiving XML items corresponding to generating outputs; and
a communications network operably coupled between said first computing system and said second computing system for transmitting data between said first computing systems and said second computing system.

21. A method for providing remote computer access, comprising:
receiving instructions relating to generating output;
creating data defining at least one XML item corresponding to the instructions relating to generating output;
transmitting the data defining at least one XML item;
receiving data defining an XML item relating to inputs;
creating instructions relating to inputs from the data defining an XML item relating to inputs; and
executing the instructions relating to inputs.

22. The method of claim 21, wherein receiving instructions relating to generating output comprises receiving instructions relating to generating visual or audio output.

23. The method of claim 21, wherein creating data defining at least one XML item corresponding to the instructions relating to generating output comprises generating at least a first XML tag defining the beginning of the XML item, generating a data item corresponding to the instruction relating to generating output; and generating at least a second XML tag defining the ending of the XML item.

24. The method of claim 21, wherein transmitting the data defining at least one XML item comprises transmitting the data defining at least one XML item using HTTP protocol.

25. The method of claim 21, wherein creating instructions relating to inputs from the data defining an XML item relating to inputs comprises identifying a first XML tag identifying the beginning of the XML item, identifying a data item corresponding to an input, and identifying a second XML tag identifying the ending of the XML item.

26. A method for providing remote computer access, comprising:
receiving instructions relating to user inputs;
creating data defining at least one XML item corresponding to the instructions relating to user inputs;
transmitting the data defining at least one XML item;
receiving data defining an XML item relating to outputs;
creating instructions relating to outputs corresponding to the data defining an XML item relating to outputs; and
executing the instructions relating to outputs.

26. The method of claim 25, wherein transmitting the data defining at least one XML item comprises using the HTTP protocol to transmit the data defining at least one XML item.
